(19) United States
(12) Patent Application Publication
(10) Pub. No.: US 2023/0415599 A1
(43) Pub. Date: Dec. 28, 2023

(54) System for Charging Mobile Vehicle and Method for Charging Thereof

(71) Applicants: Hyundai Motor Company, Seoul (KR); Kia Corporation, Seoul (KR)

(72) Inventors: Jae Hyuk Choi, Seoul (KR); Bo Kyung Yoon, Incheon (KR); Byeong Seob Song, Suwon-si (KR); Ho Young Jung, Hwaseong-si (KR)

(73) Assignees: Hyundai Motor Company, Seoul (KR); Kia Corporation, Seoul (KR)

(21) Appl. No.: 17/983,202

(22) Filed: Nov. 8, 2022

(30) Foreign Application Priority Data
Jun. 27, 2022 (KR) 10-2022-0078299

(51) Int. Cl. B60L 53/62; B60L 50/60; B60L 53/18; B60L 53/16; B60L 58/24; B60L 58/12; B60L 53/57

(52) U.S. Cl. CPC B60L 53/62; B60L 50/60; B60L 53/18; B60L 53/16; B60L 2240/549; B60L 58/12; B60L 53/57; B60L 2240/545; B60L 2240/547; B60L 58/24

(57) ABSTRACT

An embodiment system includes a mobile charger and a vehicle. The vehicle includes a connection port designed to interface with the mobile charger and a vehicle battery. A vehicle battery management unit is configured to control a current and a voltage of charging and output by detecting a temperature, a current, and a voltage in each module of the vehicle battery. A power conversion unit includes a motor and an inverter and is configured to convert a voltage received at the connection port to a magnitude of voltage that charges the vehicle battery. A charging management unit is coupled to the second battery management unit and the power conversion unit.

### CROSS-REFERENCE TO RELATED APPLICATIONS

This application claims the benefit of Korean Patent Application No. 10-2022-0078299, filed on Jun. 27, 2022, which application is hereby incorporated herein by reference.

### TECHNICAL FIELD

The present invention relates to a system for charging a mobile vehicle and a method for charging thereof.

### BACKGROUND

As the supply of electric vehicles has gradually expanded recently, the construction of charging infrastructure for electric vehicles is also gradually expanding. In the charging infrastructure, most of the infrastructure is made up of AC onboard charging and DC fast charging. Most public charging stations, except for the personal onboard charging station installation, are installed with fast chargers.

However, if a user does not separate the charger and the electric vehicle or parks in the charging station after a charging of the electric vehicle is completed, the users of other electric vehicles may not use the chargers.

As such, Korean Patent Application No. 10-1852118, filed on 19 Apr. 2018, and entitled “A mobile charging system and an operation method thereof,” has proposed a mobile charging system that provides charging by moving a charger to the location of a vehicle.

The mobile charging system described above is a system to improve battery deficit and charging convenience for users of electric vehicles. The mobile charging system is embedded with a battery, which is an energy storage device to store electrical energy, and to transfer the energy, a power conversion device for charging is embedded internally. However, due to the above, the mobile charging systems need to configure batteries and power devices occupy a large volume/weight, and there is a limit reducing the volume and weight of the mobile charging system. Due to such limitations, although the mobile charging system is made for mobility and portability, there is a disadvantage in that practicability is poor as the system is inconvenient to move and has a high cost.

As such, Korean Patent Publication No. 10-2020-0123337, filed on Oct. 29, 2020, and entitled “Battery to vehicle charging system,” has proposed a battery-to-vehicle (B2V) using an electric vehicle on-board charger (EV OBC) by removing the power converter device to overcome the disadvantage of the mobile charging system described above. However, the standard B2V charging system has a disadvantage because the charging speed is slow because of the OBC (on-board charger).

Therefore, in embodiments of the present invention, there is a need for a method for charging an electric vehicle capable of reducing the volume and weight of a mobile charger and improving the charging speed.

### SUMMARY

The present invention relates to a system for charging a mobile vehicle and a method for charging thereof. Particular embodiments relate to a system for charging a mobile vehicle and a method for charging thereof capable of fast charging a vehicle without having a power conversion device in a mobile charger.

Therefore, embodiments of the present invention consider problems in the art, and an embodiment of the present invention provides a system for charging a mobile vehicle and a method for charging thereof with the improved volume and weight of the mobile charger.

Another embodiment of the present invention provides a system for charging a mobile vehicle and a method for charging thereof with improved heat generation and charging speed.

Another embodiment of the present invention provides a system for charging a mobile vehicle and a method for charging thereof with reduced manufacturing cost.

Embodiments of the present invention are not limited to the embodiments described above, and other embodiments not described will be clearly understood by those skilled in the art to which the present invention pertains.

According to one embodiment of the present invention, there is provided a system for charging a mobile vehicle including a mobile charger including a controller controlling the entire charging process of the mobile charger, a first battery management unit controlling current and voltage of charging and output by detecting temperature, current, and voltage in each module of a first battery, and the first battery storing electrical energy for charging a vehicle. The vehicle includes a charging management unit controlling the entire charging process of the vehicle, a second battery management unit controlling current and voltage of charging and output by detecting temperature, current, and voltage in each module of a second battery, and a power conversion unit including a motor and an inverter, while converting the voltage supplied from the first battery to the magnitude of voltage that charges the second battery, and the second battery storing electrical energy for driving the vehicle.

In this case, the mobile charger may further include a mode switch for converting an operating mode between a charging mode and a discharging mode.

Here, the mobile charger may further include a charging port connecting a bidirectional charging cable.

Here, the controller may determine whether a control pilot pulse width modulation (CP PWM) duty cycle is 5% when a mode set in the mode switch is the charging mode and performs charging of the mobile charger when the CP PWM duty cycle is 5%.

Here, the mobile charger may further include an insulation checking unit that checks the insulation of a charging cable.

Here, the mobile charger may further include a relay to turn on and off a power that is supplied to the insulation checking unit.

When a cable of the mobile charger is connected to the vehicle, the controller turns the relay on, the insulation checking unit checks the insulation of the charging cable, and when completing the insulation checking of the charging cable, the controller charges the vehicle via the mobile charger.

In addition, a method for charging a vehicle by a mobile vehicle charger according to an embodiment of the present invention may include the steps of determining an operating mode by checking a mode set on a mode switch when a charging cable is connected to a charging port, performing a transmitting or charging operation according to the operating mode, switching a charging state of the mobile vehicle charger to a standby state when the transmitting or charging operation is ended, and disconnecting the charging cable.

Here, when the operating mode is in a transmission mode, the method may further include performing an initial transmission setting and performing a DC transmission sequence.

Here, when the operating mode is in the charging mode, the charging method of the vehicle may further include determining whether a CP PWM duty cycle is 5%.

Here, when the CP PWM duty cycle is 5%, the charging method of the vehicle may further comprise performing an initial transmission setting and performing a DC transmission sequence.

Here, the charging cable may be a bidirectional charging cable.

Here, the step of determining the operating mode may be performed when the bidirectional charging cable is connected to both the mobile vehicle charger and the vehicle.

In addition, in charging a vehicle by a mobile vehicle charger, the method may further include the steps of performing an initial charging setting when the charging cable is connected to the vehicle, turning on the relay that supplies power to the insulation checking unit, checking the insulation of the charging cable by the insulation checking unit, turning off the relay, and performing a charging of the vehicle.

Here, the step of performing the charging of the vehicle may further include performing a pre-charge sequence and performing an energy transfer sequence.

Here, the method may further include checking whether the charging of the vehicle is ended and disconnecting the charging cable when the charging of the vehicle is ended.

According to various embodiments of the present invention described above, a system for charging a mobile vehicle that has improved the volume and weight of a mobile charger may be provided by removing the power conversion device.

In addition, the heat generation and charging speed of a fast mobile charger may be improved and may reduce the manufacturing cost.

It will be appreciated by persons skilled in the art that that the effects that can be achieved with embodiments of the present invention are not limited to what has been particularly described herein above and other advantages of embodiments of the present invention will be more clearly understood from the following detailed description taken in conjunction with the accompanying drawings.

### BRIEF DESCRIPTION OF THE DRAWINGS

FIG. 1 is a view showing a general structure of a conventional mobile vehicle charging system.

FIG. 2 is a view showing a general structure of a mobile vehicle charging system according to an embodiment of the present invention.

FIG. 3 is a view showing a general structure of a mobile vehicle charger according to an embodiment of the present invention.

FIG. 4A is a view showing one embodiment of a charging port that can be applied to the mobile vehicle charger of FIG. 3.

FIG. 4B is a view showing one embodiment of a charging cable that can be applied to the mobile vehicle charger of FIG. 3.

FIG. 5 is a flowchart showing a charging/discharging method of a mobile vehicle charger according to an embodiment of FIG. 3.

FIG. 6 is a view showing a general structure of a mobile vehicle charger according to another embodiment of the present invention.

FIG. 7 is a flowchart showing a charging method of a mobile vehicle charger according to the embodiment of FIG. 6.

FIG. 8 is a graph showing the state of each component according to each charging step of the DC fast charging standard in IEC 61851-23.

FIG. 9 is a view showing various embodiments of vehicle chargers.

FIGS. 10A and 10B are views showing a mobile vehicle charger according to embodiments of the present invention.

### DETAILED DESCRIPTION OF ILLUSTRATIVE EMBODIMENTS

Hereinafter, embodiments of the present invention will be described in greater detail with reference to the accompanying drawings. In describing embodiments of the present invention, for ease of understanding, the same reference numerals are used to denote the same components throughout the drawings, and repetitive description on the same components will be omitted. In the following description, with respect to constituent elements used in the following description, suffixes “module” and “unit” are given only in consideration of facilitation of description and do not have meanings or functions discriminated from each other. In addition, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit technical ideas disclosed in the present specification. Therefore, it should be understood that the accompanying drawings include all modifications, equivalents and substitutions within the scope and spirit of the present invention.

It will be understood that although the terms first, second, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In embodiments of the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

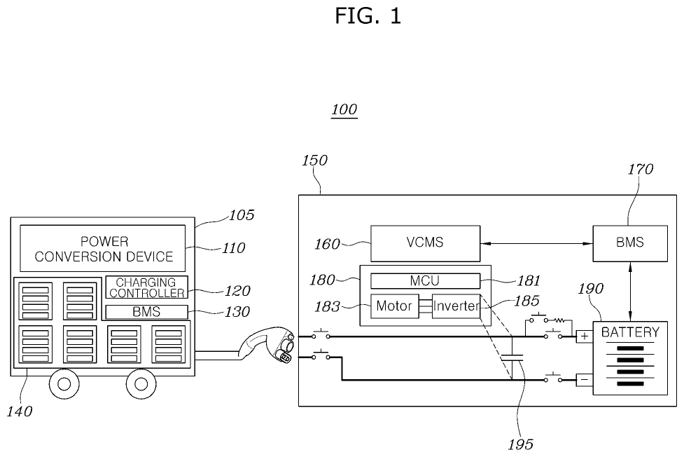

FIG. 1 is a view showing a general structure of a conventional mobile vehicle charging system.

In FIG. 1, the conventional mobile vehicle charging system 100 includes a mobile charger 105 and an electric vehicle 150.

The mobile charger 105 includes a power conversion device no, a charging controller 120, a battery management system (BMS) 130, and a battery 140. The power conversion device no generates charging power supplied to the vehicle 150 by using the power energy stored in the battery 140. The power conversion device no may be a DC-DC converter. The charging controller 120 controls the entire charging operation of the mobile charger 105. The BMS 130 controls the current and voltage for charging and output by detecting the temperature, current, and voltage of each module of the battery 140. The battery 140 stores the electrical energy for charging the vehicle 150 and may be configured in a plurality of battery modules.

Meanwhile, the vehicle 150 includes a vehicle charging management system (VCMS) 160, a battery management system (BMS) 170, a driving unit 180, a battery 190, and a link capacitor 195. The VCMS 160 manages the charging of the vehicle iso. The BMS 170 controls the current and voltage for charging and output by detecting the temperature, current, and voltage of each module of the battery 190. The driving unit 180 drives the vehicle 150 by transferring the electrical energy stored in the battery 190. The driving unit 180 comprises a microcontroller unit (MCU) 181, a motor 183, and an inverter 185. The battery 190 stores the electrical energy for driving the vehicle 150 and may be configured with a plurality of battery modules. The link capacitor 195 charges the power supplied from the mobile charger 105. The link capacitor 195 may be charged by a voltage of 800 V.

In the system described above, the power conversion device no comprises about 20 to 30% of the total volume of the mobile charger 105. The power conversion device no increases in size as the output increases, making it inconvenient to move the portable charger 105 and causing heat generation. Accordingly, when the power conversion function of the power conversion device no is replaced by using other components equipped in the vehicle 150, the volume of the mobile charger 105 may be reduced, and the heat generation may be improved.

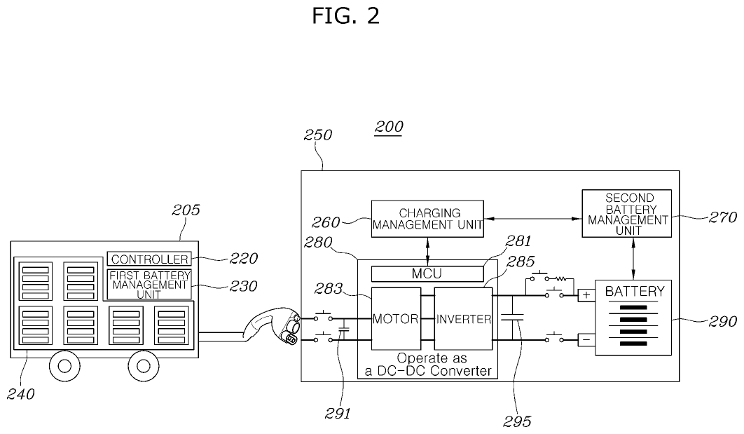

FIG. 2 is a view showing a general structure of a mobile vehicle charger according to an embodiment of the present invention.

In FIG. 2, a mobile vehicle charging system according to embodiments of the present invention includes a mobile charger 205 and a vehicle 250.

The mobile charger 205 includes a controller 220, a first battery management unit 230, and a first battery 240. The controller 220 controls the entire charging process of the mobile charger 205. The first battery management unit 230 controls the current and voltage for charging and output by detecting the temperature, current, and voltage of each module of the first battery 240. The first battery 240 stores the electrical energy for charging the vehicle 250 and may be configured with a plurality of battery modules.

Meanwhile, the vehicle 250 includes a charging management unit 260, a second battery management unit 270, a power conversion unit 280, a second battery 290, and first and second capacitors 291 and 295. The charging management unit 260 controls the entire charging operation of the mobile charger 205. The second battery management unit 270 controls the current and voltage of charging and output by detecting the temperature, current, and voltage of each module of the second battery 290.

The power conversion unit 280 generates charging power for charging the second battery 290 using the electrical energy supplied from the mobile charger 205. The power conversion unit 280 converts the voltage supplied from the mobile charger 205 to the magnitude of voltage that can charge the second battery 290. That is, the power conversion unit 280 converts the voltage supplied from the mobile charger 205 to the magnitude of voltage that can charge the second battery 290. The power conversion unit 280 comprises a microcontroller unit (MCU) 281, a motor 283, and an inverter 285, and the power conversion unit 280 performs as a DC-DC converter. Here, the power conversion unit 280 may convert the voltage from 400 V to 800 V, which is supplied from the mobile charger 205 as shown in FIG. 2. The second battery 290 stores the electrical energy for driving the vehicle 250 and may be configured with a plurality of battery modules. The first capacitor 291 may charge the voltage provided from the mobile charger 205, and the second capacitor 295 may charge the voltage converted from the power conversion unit 280. The first capacitor 291 is charged by the voltage of 400 V, and the second capacitor 295 may be charged by the voltage of 800 V.

In the mobile vehicle charging system according to the present embodiment, the motor 283 and the inverter 285 in the vehicle 250 may be used as a power conversion device, even though the mobile charger 205 does not include the power conversion device for converting the voltage of the first battery 240 to a voltage that can charge the second battery 290. Therefore, the capacity of the battery may be increased compared to the same volume. In addition, when the motor 283 and the inverter 285 in the vehicle 250 are used as the power conversion device, the charging speed has the motor/inverter output as more than 10 kW, which means improved fast charging is possible compared to the conventional mobile charger.

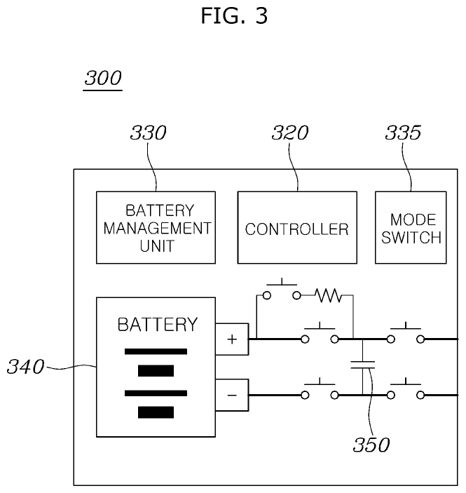

FIG. 3 is a view showing a general structure of mobile vehicle charger according to one embodiment of the present invention.

In FIG. 3, a mobile vehicle charger 300 according to the present embodiment includes a controller 320, a battery management unit 330, a mode switch 335, a battery 340, and a capacitor 350.

The controller 320 controls the entire charging operation of the mobile vehicle charger 300.

Meanwhile, the controller 320 charges the mobile vehicle charger 300 by using an external electric vehicle supply equipment (EVSE) according to the operating mode of the mode switch, or charges the battery of the vehicle using the mobile vehicle charger 300.

The battery management unit 330 controls the current and voltage for charging and output by detecting the temperature, current, and voltage of each module of the battery 340.

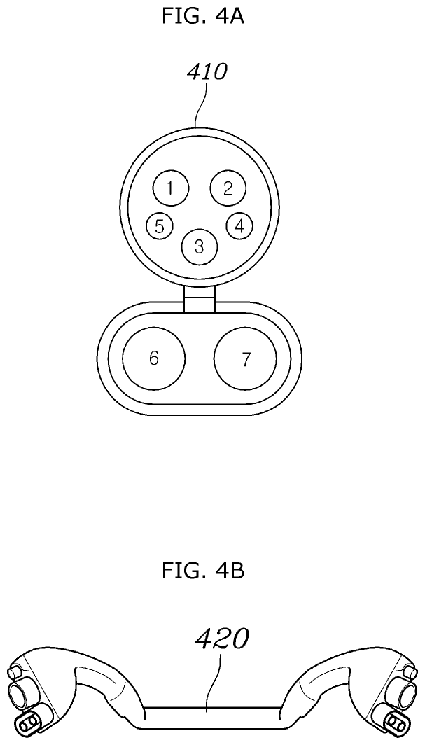

The mode switch 335 switches the operating mode of the mobile vehicle charger 300 from a charging mode to a discharging mode. That is, the operating mode of the mobile vehicle charger 300 switches from the charging mode to the discharging mode or switches the discharging mode to the charging mode. The charging mode is a mode for charging the mobile vehicle charger 300 using the external EVSE, and the discharging mode is a mode for charging the battery of the vehicle using the mobile vehicle charger 300. The mobile vehicle charger 300 may be provided with, for example, a charging port 410 as shown in FIG. 4A, and the charging port 410 may be connected with, for example, a bidirectional charging cable 420 as shown in FIG. 4B. Using the charging port 410 and the charging cable 420, the battery 340 of the mobile vehicle charger 300 is charged from the charger or the battery of the vehicle may be charged by the mobile vehicle charger 300. Here, when the battery 340 of the mobile vehicle charger 300 is charged, the battery 340 of the mobile vehicle charger 300 is charged using the same charging port 410 and the charging cable 420. When the charging port 410 is connected to other devices via the charging cable 420, it simply does not ascertain whether charging is for the mobile vehicle charger 300 or other devices. Meanwhile, the mode switch 335 is set as either a charging mode or a discharging mode. Thereby the controller 320 charges the mobile vehicle charger 300 using the external EVSE, or the battery of the vehicle is charged by using the mobile vehicle charger 300.

The battery 340 stores the electrical energy for charging the vehicle 250 and may be configured with a plurality of battery modules.

The capacitor 350 charges the voltage supplied from the battery 340. In this case, the capacitor 350 may be charged with the voltage of 400 V.

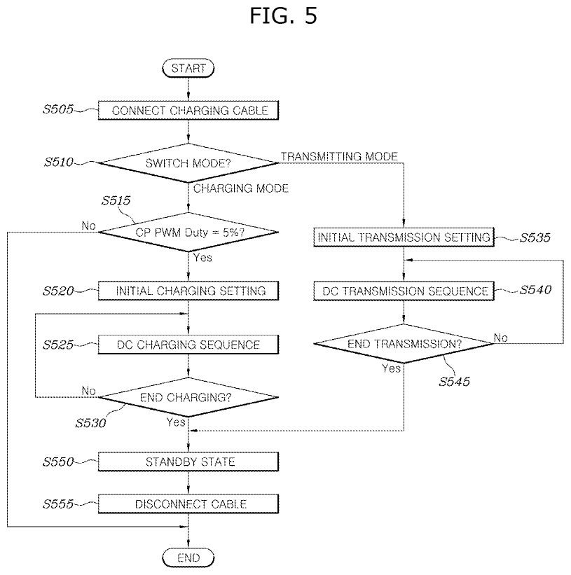

FIG. 5 is a flowchart showing a charging/discharging method of a mobile vehicle charger according to an embodiment of FIG. 3. Each step except for step S505 and S555 of FIG. 5 may be performed by the controller 320. Generally a user will install the physical connection although in some embodiments the controller 320 can control the switches (unlabeled) that open and close the electrical connections.

Referring to FIG. 5, as the charging cable is connected to the charging port of the mobile vehicle charger (S505), the controller 320 checks the mode set in the mode switch 335, thereby determining whether to operate in a transmitting mode or a charging mode (S510).

The cable may be a bidirectional charging cable capable of transmitting and charging in one cable.

Step S510 may be set to perform if the bidirectional charging cable is connected to both the mobile vehicle charger and the vehicle.

When determined to operate in the charging mode in step S510, the controller 320 determines whether a control pilot (CP) pulse width modulation (PWM) duty cycle is 5% or not (S515).

Here, the duty cycle is the time that a digital signal is in the active state with respect to the signal period. The duty cycle may be expressed generally as a percentage. For example, the duty cycle of a perfect square wave with the same high and low times is 50%.

When the CP PWM duty cycle is not 5%, the controller 320 determines that it is for performing the DC charging and ends the operation without charging during the rest of the duty cycle.

When the CP PWM duty cycle is determined as 5% in step S515, the controller 320 performs an initial charging setting (S520).

The initial charging setting may include an operation of exchanging data between the EVSE and the mobile vehicle charger 300 and recognizing each other in order to charge the mobile vehicle charger 300 from the EVSE.

The controller 320, which completed the initial charging setting, performs a DC charging sequence (S525).

The DC charging sequence includes a process of transmitting power from the EVSE to the mobile vehicle charger 300 and storing energy in the battery 340 of the mobile vehicle charger 300.

Next, the controller 320 determines whether the charging is ended (S530), and when the charging is ended, the charging state of the mobile vehicle charger 300 is switched to a standby state (S550), and the charging cable is disconnected (S555), and the operation ends.

Meanwhile, when it is determined that the transmitting mode is operated in step S510, the controller 320 performs an initial transmission setting (S535).

The initial transmission setting may include an operation of exchanging data between the EVSE and the mobile vehicle charger 300 and recognizing each other for charging the mobile vehicle charger 300.

The controller 320, which completed the initial transmission setting, performs a DC transmission sequence (S540).

The DC transmission sequence transfers the power to the vehicle from the mobile vehicle charger 300 and includes a process of storing the energy in the battery of the vehicle.

Next, the controller 320 determines whether the transmission is ended (S545) and switches the mobile vehicle charger 300 to the standby state when the transmission is ended (S550). The cable is disconnected (S555), and the operation is ended.

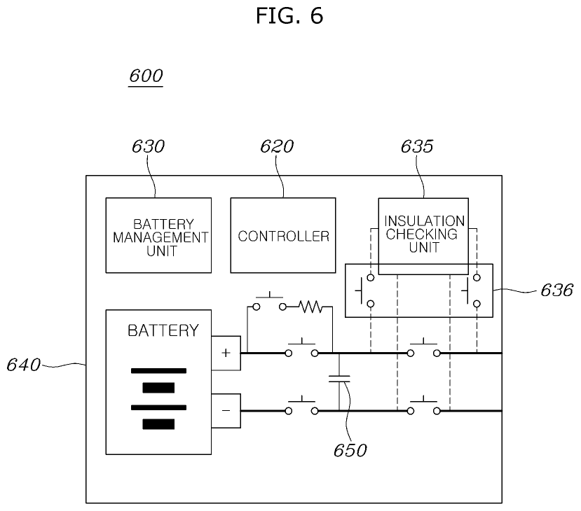

FIG. 6 is a view showing a general structure of mobile vehicle charger according to another embodiment of the present invention.

In FIG. 6, a mobile vehicle charger 600 according to the present embodiment includes a controller 620, a battery management unit 630, an insulation checking unit 635, a battery 640, and a capacitor 650.

The controller 620 controls the entire charging operation of the mobile vehicle charger 600.

The battery management unit 630 controls the current and voltage for charging and output by detecting the temperature, current, and voltage of each module of the battery 640.

The insulation checking unit 635 checks the insulation of the charging cable of the mobile vehicle charger 600. A general mobile vehicle charger checks a DC-DC converter disposed inside of the power converting device of FIG. 1, however, in the present embodiment, since the power is converted in the MCU, the motor, and the inverter of the vehicle, a separate power conversion device in the mobile vehicle charger 600 does not exist. The insulation checking unit 635 checks the insulation of the charging cable.

A relay 636 turns the power source on and off that is provided to the insulation checking unit 635. Since the insulation checking unit 635 checks the insulation of the charging cable once when the charging cable is connected to the vehicle, instead of checking periodically during charging when insulation checking is completed, the power is no longer required to be supplied to the insulation checking unit 635. Therefore, when the charging cable is connected to the vehicle, the relay 636 turns a switch on that supplies the power to the insulation checking unit 635, thereby supplying the power to the insulation checking unit 635. Thereafter, once the insulation checking is done by the insulation checking unit 635, the relay 636 turns off the switch that supplies power to the insulation checking unit 635 again, thereby cutting off the power supplied to the insulation checking unit 635.

The battery 640 stores the electrical energy for driving the vehicle and may be configured with a plurality of battery modules.

The capacitor 650 charges the voltage supplied from the battery 640. In this case, the capacitor 650 may be charged with the voltage of 400 V.

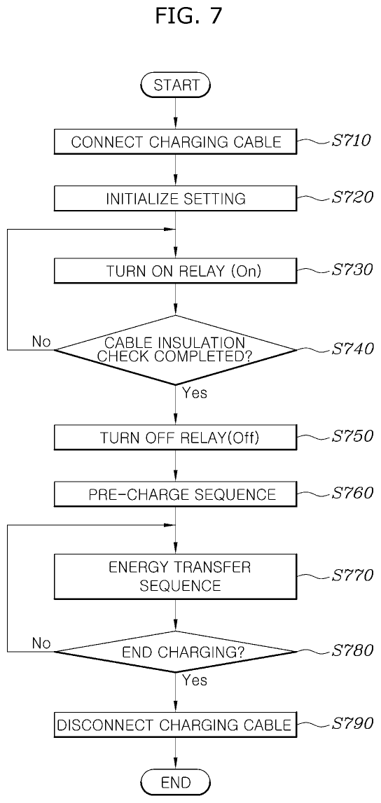

FIG. 7 is a flowchart showing a charging method of a mobile vehicle charger according to the embodiment of FIG. 6. As noted above with respect to FIG. 5, except for steps S710 and S790 of FIG. 7, each step may be performed by the controller 620.

In FIG. 7, when the cable of the mobile vehicle charger is connected (S710), the controller 620 performs an initial charging setting (8720).

The initial charging setting may perform existing operations in an initialization sequence of the DC fast charging standard of IEC 61851-23.

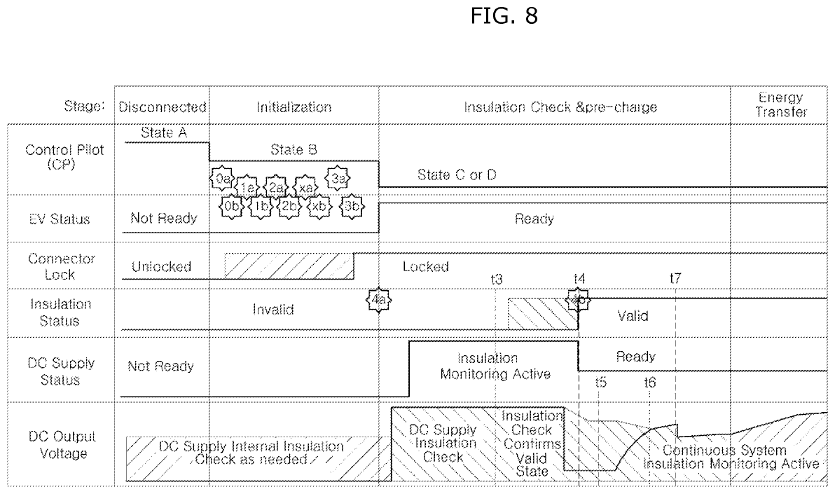

For example, in FIG. 8, a control pilot (CP) is switched to state B from state A, and a connector lock is switched to a locked state from an unlocked state.

Referring to FIG. 7 again, by allowing the controller 620 to turn the relay on, which is to supply the power to the insulation checking unit 635, the insulation checking unit 635 checks the cable insulation (8730).

The controller 620 confirms whether the cable insulation check by the insulation checking unit 635 is completed (8740). Once the cable insulation checking is completed, the relay is turned off which was supplying the power to the insulation checking unit 635 (8750).

When the cable insulation is not checked, the controller 620 continuously maintains the relay to be turned on so that power is supplied to the insulation checking unit 635 until the cable insulation is checked.

Next, the controller 620 performs a pre-charge sequence for charging (8760).

At this time, the pre-charge sequence may perform existing operations in the pre-charge sequence of the DC fast charging standard of IEC 61851-23.

For example, in FIG. 8, the control pilot (CP) is switched to state C or state D from state B, and the DC supply status may be switched to the ready state from the not ready state.

Referring to FIG. 7 again, the controller 620 performs the energy transfer sequence (8770).

The initial charging setting may perform existing operations in the energy transfer sequence of the DC fast charging standard of IEC 61851-23.

Next, the controller 620 confirms whether charging of the vehicle is ended (S780). When charging is ended, the cable is disconnected (8790), and the operation ends. Meanwhile, when charging is not ended after checking step S780, the controller 620 continuously performs the energy transfer sequence until charging ends (S770).

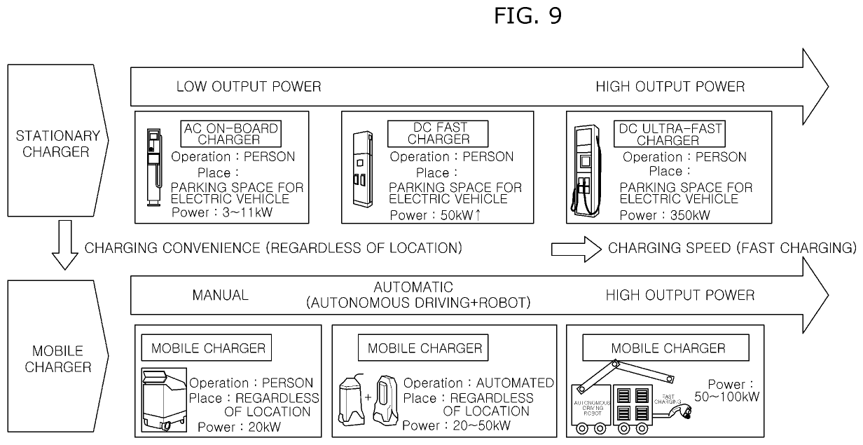

FIG. 9 is a view showing various embodiments of vehicle chargers.

Referring to FIG. 9, the vehicle charger may be classified into a stationary charger and a mobile charger depending on the mobility of the vehicle charger.

The stationary charger includes an AC on-board charger, a DC fast charger, and a DC ultra-fast charger depending on the output method and charging speed.

Meanwhile, the conventional mobile charger included a manual mobile charger and an automatic mobile charger, and all of them had a power conversion device therein, so there was a limitation to the charging capacity and the charging speed. However, the mobile charger according to embodiments of the present invention does not require a B2V charging method, which performs the fast charging of electric vehicles from the mobile battery using an EV motor and an inverter as a power converting device. In other words, since a separate power conversion device is not required, there are advantages in that the charger is small in volume, light in weight, and has a fast-charging speed.

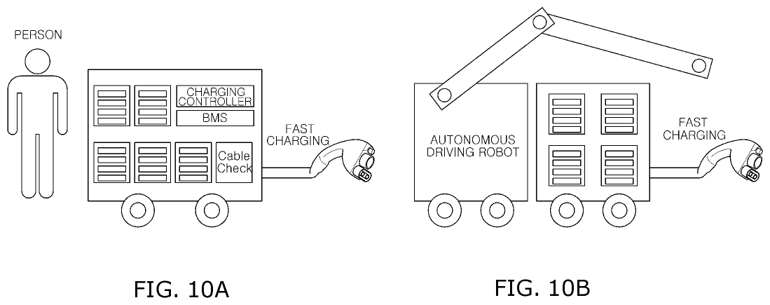

FIGS. 10A and 10B are views showing a mobile vehicle charger according to embodiments of the present invention. FIG. 10A is a view showing a manual mobile charger that a person performs transportation, and FIG. 10B is a view showing an automatic mobile charger that can automatically move to a vehicle location using an autonomous driving robot and the like. As shown in FIGS. 10A and 10B, the mobile vehicle charger according to embodiments of the present invention may be implemented in the forms of both the manual mobile charger and the automatic mobile charger like the conventional mobile vehicle charger.

According to embodiments of the present invention described above, the mobile charger that applied a fast B2V charging technology which does not require a separate power device, and since a power conversion device is removed, a mobile charger, in which the limitations like manufacturing cost and size reduction are improved, may be provided.

In addition, a drawback, such as heat generation of the high output power conversion device that has not been solved in the conventional mobile charger, can be overcome by using the EV motor and inverter.

In addition, since the power conversion device in the mobile charger is removed, the loading rate of the battery may be increased, and it is advantageous in increasing the battery charging capacity.

In addition, using the EV motor and the inverter as the power converting device, a high output (more than 100 kW=motor/inverter output) compared to the conventional mobile charger is possible, and the charging speed is fast compared with the same volume.

B2V charging technology can also be applied to systems using waste batteries, and the residual value of used batteries can be increased.

In addition, the mobile vehicle charger can contribute to the expansion of the electric vehicle market by providing charging convenience for electric vehicle users.

Embodiments of the present invention mentioned in the foregoing description may be implemented as code that can be written to a computer-readable recording medium and can thus be read by a computer system. The computer-readable medium may include all kinds of recording devices in which data readable by a computer system is stored. Examples of computer-readable mediums include a hard disk drive (HDD), a solid state disk (SSD), a silicon disk drive (SDD), a ROM, a RAM, a CD-ROM, a magnetic tape, a floppy disk, an optical data storage device, and the like. Therefore, the above embodiments are therefore to be construed in all aspects as illustrative and not restrictive. The scope of the present invention should be determined by the appended claims and their legal equivalents, not by the above description, and all changes coming within the meaning and equivalent range of the appended claims are intended to be embraced therein.

What is claimed is:

1. A vehicle comprising:
a connection port designed to interface with a charger;
a vehicle battery;
a vehicle battery management unit configured to control a current and a voltage of charging and output by detecting a temperature, a current, and a voltage in each module of the vehicle battery;
a power conversion unit comprising a motor and an inverter and configured to convert a voltage received at the connection port to a magnitude of voltage that charges the vehicle battery; and
a charging management unit coupled to the vehicle battery management unit and the power conversion unit.

2. A system comprising:
the vehicle of claim 1; and
a mobile charger comprising a connection port designed to interface with the connection port of the vehicle and a mobile charger battery, wherein the mobile charger does not include a power conversion unit such that a voltage that can be output by the mobile charger has the same magnitude as a voltage of the mobile charger battery.

3. A system comprising:
the vehicle of claim 1; and
a mobile charger comprising:
a controller configured to control a charging process of the mobile charger;
a mobile charger battery; and
a mobile charger battery management unit configured to control a current and a voltage of charging and output by detecting a temperature, a current, and a voltage in each module of the mobile charger battery.

4. The system of claim 3, wherein the mobile charger further comprises a mode switch configured to switch an operating mode between a charging mode and discharging mode.

5. The system of claim 4, wherein the controller is configured to:
determine whether a control pilot pulse width modulation (CP PWM) duty cycle is 5% when the operating mode is the charging mode; and
perform charging of the mobile charger when the CP PWM duty cycle is 5%.

6. The system of claim 3, wherein the connection port of the mobile charger comprises a charging port configured to connect with a bidirectional charging cable.

7. The system of claim 3, wherein the mobile charger further comprises an insulation checking unit configured to check an insulation of a charging cable.

8. The system of claim 7, wherein the mobile charger further comprises a relay configured to turn on or off a power that is supplied to the insulation checking unit.

9. The system of claim 8, wherein when a cable of the mobile charger is connected to the vehicle, the mobile charger is configured to turn the relay on and the insulation checking unit is configured to check the insulation of the charging cable, and after the insulation of the charging cable is checked, the mobile charger is configured to charge the vehicle.

10. A method for charging a vehicle by a mobile vehicle charger, the method comprising:
determining an operating mode by checking a mode set on a mode switch when a charging cable is connected to a charging port;
performing a transmitting operation or a charging operation according to the operating mode;
switching a charging state of the mobile vehicle charger to a standby state when the transmitting operation or the charging operation is ended; and
disconnecting the charging cable.

11. The method of claim 10, wherein, when the operating mode is a transmitting mode, the method further comprises:
performing an initial transmission setting; and
performing a DC transmission sequence.

12. The method of claim 10, wherein, when the operating mode is a charging mode, the method further comprises determining whether a control pilot pulse width modulation (CP PWM) duty cycle is 5%.

13. The method of claim 12, wherein when the CP PWM duty cycle is 5%, the method further comprises:
performing an initial transmission setting; and
performing a DC transmission sequence.

14. The method of claim 10, wherein the charging cable is a bidirectional charging cable.

15. The method of claim 14, wherein determining the operating mode is performed when the bidirectional charging cable is connected to both the mobile vehicle charger and the vehicle.

16. The method of claim 10, further comprising checking an insulation of the charging cable using an insulation checking unit.

17. The method of claim 16, further comprising, when the charging cable is connected to the vehicle, supplying power to the insulation checking unit, checking the insulation of the charging cable, and after checking the insulation of the charging cable, charging the vehicle via the mobile vehicle charger.

18. A method for charging a vehicle by a mobile vehicle charger, the method comprising:
performing an initial charging setting when a charging cable is connected to the vehicle, the charging cable comprising an electrical conductor surrounded by an insulation;
turning on a relay;
checking the insulation of the charging cable while the relay is turned on;
turning off the relay; and
charging the vehicle after turning off the relay.

19. The method of claim 18, wherein charging the vehicle further comprises:
performing a pre-charge sequence; and
performing an energy transfer sequence.

20. The method of claim 19, further comprising:
determining whether the charging the vehicle is ended; and
disconnecting the charging cable in response to a determination that the charging the vehicle is ended.
